(19) United States
(12) Patent Application Publication
(10) Pub. No.: US 2010/0227519 A1
(43) Pub. Date: Sep. 9, 2010

(54) POLYMER-FILM-LAMINATED ACTIVATED-CARBON PAPER

(75) Inventors: Robert Randall Soper, Alexandria, VA (US); Roger Dale Hall, Frederick, MD (US); Frederick Joseph Bures, JR., Baltimore, MD (US); Michael Ford Tschantz, Lexington, VA (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Glen Allen, VA (US)

(21) Appl. No.: 12/280,033

(22) PCT Filed: Mar. 12, 2007
(86) PCT No.: PCT/US2007/063763

§ 371 Date: Aug. 20, 2008

Related U.S. Application Data
(60) Provisional application No. 60/786,514, filed on Mar. 28, 2006.

(51) Int. Cl. D03D 9/00; B32B 5/02

(52) U.S. Cl. 442/1; 428/292.1

(57) ABSTRACT

A product and method of manufacture is described for a highly filled activated carbon material with a polymer surface layer for strength.

### REFERENCE TO RELATED APPLICATION

This Non-Provisional Application relies on the filing date of Provisional Application Ser. No. 60/786,514 filed on Mar. 28, 2006 having been filed within 12 months thereof which is incorporated herein by reference in its entirety, and the priority thereto is claimed under 35 USC §1.19 (e).

### BACKGROUND

The use of sorbtion papers for both air and liquid filtration is well-known and represents a well-developed art. U.S. Pat. No. 4,289,513 describes a sorbtion paper containing activated carbon as a sorbent and a latex type binder material. Such sorbtion papers may be used in devices to control hydrocarbon evaporation losses from automobiles. Another use for such activated sorbtion paper is in combination with body waste devices such as sanitary napkins, disposable diapers and the like.

### SUMMARY

This invention relates to a sorbtion paper that utilizes a polymer laminated layer to produce a sheet structure with greater strength.

### BRIEF DESCRIPTION OF THE DRAWINGS

FIG. 1 illustrates a cross section view of a typical fibrous web; and

FIG. 2 illustrates a cross section view of a fibrous web containing particulate inclusions; and

FIG. 3 illustrates a cross section view of a fibrous web containing particulate inclusions and having a reinforcing layer; and

FIG. 4 illustrates a cross section view of a fibrous web containing particulate inclusions and having a reinforcing layer along with a reinforcing mesh.

### DETAILED DESCRIPTION

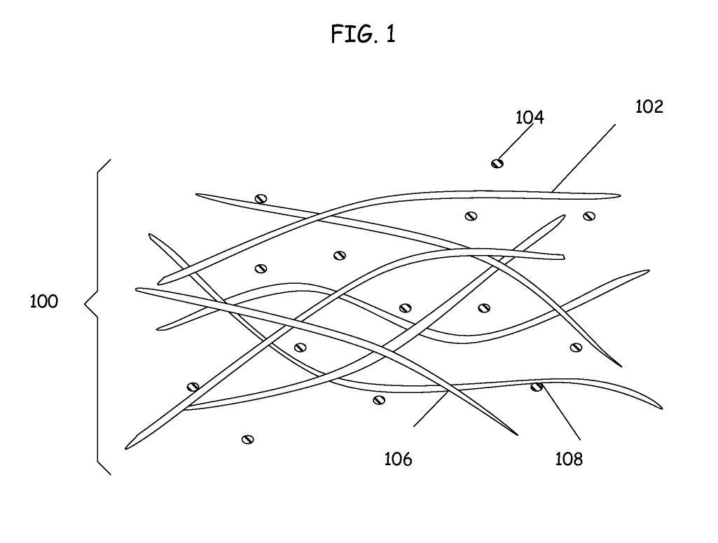

FIG. 1 illustrates a microscopic cross section view of a typical fibrous web 100 which includes fibers 102 such as cellulose fibers. The drawing is for illustration purposes and not necessarily to scale. Furthermore it may represent only a portion of the fibrous web, for example one of its surfaces. Typically the fibers would run in several directions, for example in the plane of the cross section as represented by fibers 102, and normal to the plane or at other directions as represented by fibers 104. At points where fibers cross each other more or less in the same plane, as at point 106, or cross each other at other angles such as a skewed crossing as at point 108, there may be some interfiber bonding, for example by hydrogen bonds that may be developed during a wet formation process such as occurs at the wet end of a paper machine. The fibers may typically be prepared by refining or other processes that fibrillate the fibers, so as to enhance the eventual fiber bonding and give greater strength. Additives may also be used as is well known in the art of papermaking

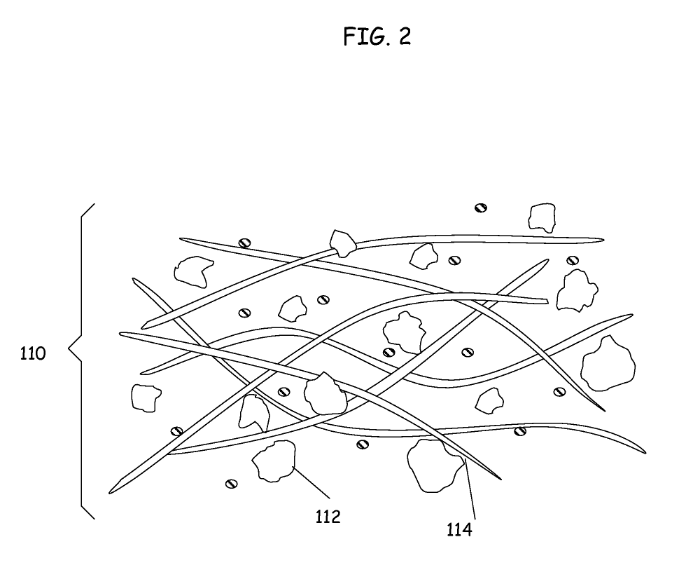

FIG. 2 illustrates a microscopic cross section view of a typical fibrous web 110 containing particulate inclusions 112. For example, the particulate may be an adsorbent material such as activated carbon that may give the particulate and fibrous web composite properties useful as a sorbtion paper. The particulates may be used in relatively high amounts, for example using more than 40% by weight of carbon in a web. Where the particulates 112 contact fibers, such as at point 114, little bonding would be expected, as the particulate may not be amenable to hydrogen bonding to the fibers. Thus, particularly at the particulates near the outer surface of the fibrous web 110, particulates may come loose during handling or usage, causing undesirable “dusting” behavior. Also, because of low tensile and tear strength, it may be difficult to attach the web to complex shaped surfaces.

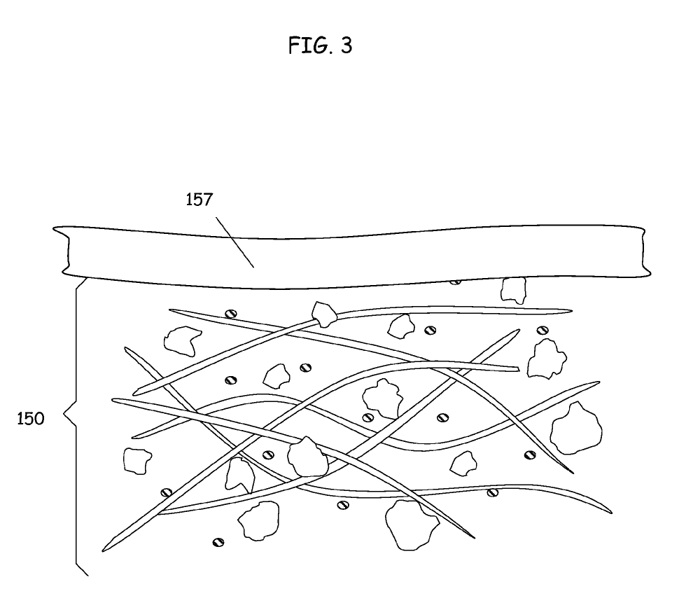

FIG. 3 illustrates a microscopic cross section view of a fibrous web 150 containing particulate inclusions and having a surface reinforcing layer 157. Such a reinforcing layer 157 could for example be a hot pressed polymer film such as low-density polyethylene film, ethylene vinyl acetate or ethylene methyl acrylate with or without binder, an extrusion laminated polyester, polypropylene, or cross-laminated high density polyethylene film (i.e. VALERON made by Valeron Strength Films), or an extrusion coated material such as polypropylene. It is understood that during extrusion lamination, two layers (e.g., fibrous web and film such as plastic) are typically adhered together by means of an adhesive layer or tie layer extruded between the fibrous web and film. The reinforcing layer 157 may provide desired mechanical properties, such as improved tear resistance, or improved tensile strength.

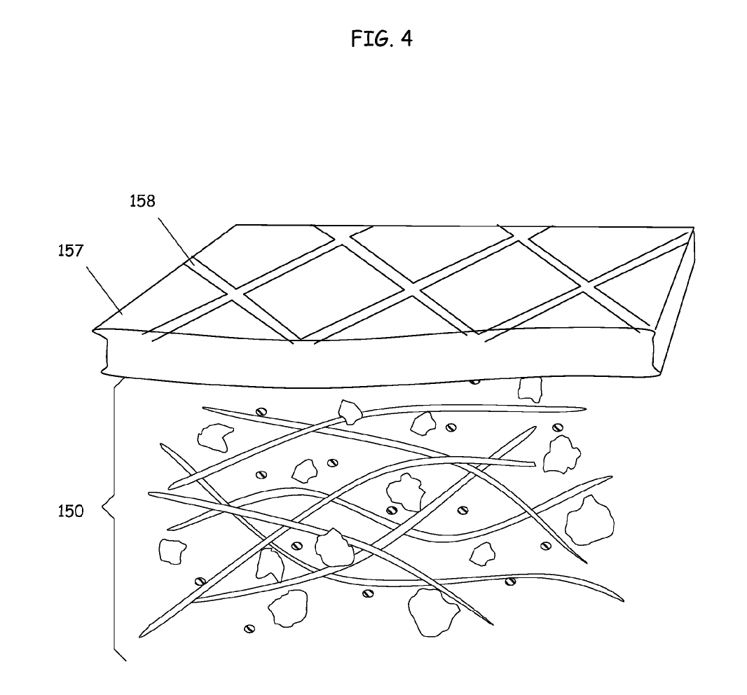

Additional means of strengthening the product include using micro- or macro permeable barriers or coatings, or adhering wire or mesh (either plastic or metal) reinforcements to the surface. FIG. 4 shows an example of a mesh 158 used along with a reinforcing layer 157. Depending on application, the mesh 158 could be used with or without layer 157. If used without layer 157, the mesh 158 may require an adhesive to attach it to the web 150.

The strengthening layer provides added strength and improved handling properties to the product by its application to one surface, while still leaving the opposite surface open. Such a strengthening layer if applied may allow for the fibrous web itself to have somewhat lower strength characteristics, for example, to be more open, less consolidated, have higher particulate content, or have a lower binder content. A strengthening layer may make the product more durable during handling, and may reduce or eliminate dusting from the surface to which it is applied. If the product is stacked in sheet form, or wound into roll form, inter-layer abrasion may be reduced by a strengthening layer. A strengthening layer may also provide better adhesion of the product to other surfaces, for example when incorporating the product into other manufactured products. For example, one use of the strengthened product is for a lining to be used in air handling components such as the engine intake air system of an internal combustion engine.

Such a strengthening layer may also be applied to other fibrous products for similar purposes.

The resulting product retains the adsorptive characteristics of the particulate material while providing stronger sheet product in a form that is easily incorporated into other structures. Incorporation can be achieved by a variety of methods including, but not limited to, hot melt adhesive, lamination to a thermoplastic film, thermofusing, hot molding, riveting, addition of pressure sensitive adhesives, or any combination thereof

Methods of making and using the filled structure in accordance with the invention are be readily apparent from the mere description of the structure and its varied appearances as provided herein.

While preferred embodiments of the invention have been described and illustrated, it is apparent to the average skilled artisan that many modifications to the embodiments and implementations of the invention can be made without departing from the spirit or scope of the invention. Although the preferred embodiments illustrated herein have been described in connection with a filled activated carbon structure, these embodiments may easily be implemented in accordance with the invention in other structures having other functionalities.

It is to be understood therefore that the invention is not limited to the particular embodiments disclosed (or apparent from the disclosure) herein, but only limited by the claims appended hereto.

What is claimed as new and desired to be protected by Letters Patent of the United States is:

1. A fiber sheet product comprising discontinuous fibers, having a binder material on at least a portion of said fibers and particulate material adhered to said fibers by said binder material, and a reinforcing layer on one surface of said sheet product.

2. The product according to claim 1 in which said particulate material is absorbent or adsorbent.

3. The product according to claim 2 in which said particulate material is activated carbon.

4. The product according to claim 1 in which said discontinuous fibers include cellulosic fibers.

5. The product according to claim 4 in which said discontinuous cellulosic fibers comprise wood pulp fibers.

6. The product according to claim 5 in which said wood pulp fibers are a majority of said discontinuous fibers.

7. The product according to claim 1 wherein said reinforcing layer is a polymer film or coating.

8. The product according to claim 1 wherein said reinforcing layer is applied by hot pressing.

9. The product according to claim 1 in which said reinforcing layer is applied by extrusion lamination.

10. The product according to claim 1 in which said reinforcing layer is applied by extrusion coating.

11. The product according to claim 1 in which said reinforcing layer comprises a mesh or wire made of plastic or metal.

12. The product according to claim 1 in which said reinforcing layer comprises a micro-permeable or macro-permeable membrane.
